(19) United States
(12) Patent Application Publication
(10) Pub. No.: US 2014/0162162 A1
(43) Pub. Date: Jun. 12, 2014

(54) Fuel Cell System Hot Box Insulation

(71) Applicant: Bloom Energy Corporation, Sunnyvale, CA (US)

(72) Inventors: Vlad Kalika, San Jose, CA (US); David Edmonston, Santa Cruz, CA (US); Michael Petrucha, Santa Clara, CA (US); John Matthew Fisher, San Jose, CA (US); Martin Perry, Mountain View, CA (US); Virpaul Bains, Union City, CA (US); James Szweda, Campbell, CA (US)

(73) Assignee: Bloom Energy Corporation, Sunnyvale, CA (US)

(21) Appl. No.: 14/082,651

(22) Filed: Nov. 18, 2013

Related U.S. Application Data
(60) Provisional application No. 61/728,290, filed on Nov. 20, 2012.

(51) Int. Cl. H01M 8/04

(52) U.S. Cl. CPC H01M 8/04701
USPC 429/456; 429/535; 429/469; 429/452

(57) ABSTRACT

A method of insulating a base portion of a fuel cell system including pouring an insulation that can be poured to fill at least 30 volume % of a base portion cavity of the fuel cell system housing through an opening in a sidewall of the housing. The base portion cavity of the housing is located between a bottom wall of the housing and a stack support base plate located in the housing. The stack support base plate supports one or more columns of fuel cell stacks.

### FIELD

The present invention is directed to fuel cell systems, specifically to insulation for a solid oxide fuel cell (SOFC) system hot box.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

To maintain high efficiency, a desired temperature of the fuel cells should be maintained throughout operation. However, gaps within layers in the fuel cell hot box and instrumentation feed-thru holes may introduce significant heat leaks, resulting in undesired temperature variation.

### SUMMARY

An embodiment relates to a method of insulating a base portion of a fuel cell system including pouring an insulation that can be poured to fill at least 30 volume % of a base portion cavity of the fuel cell system housing through an opening in a sidewall of the housing. The base portion cavity of the housing is located between a bottom wall of the housing and a stack support base plate located in the housing. The stack support base plate supports one or more columns of fuel cell stacks.

Another embodiment relates to a fuel cell system including a housing having a base portion cavity. The base portion cavity of the housing is located between a bottom wall of the housing and a stack support base plate located in the housing. The stack support base plate supports one or more columns of fuel cell stacks and the system includes insulation that can be poured in the base portion cavity.

Another embodiment relates to a method of insulating a sidewall of a fuel cell system housing including providing a compliant insulating layer between the sidewall and a resilient insulating material.

Another embodiment relates to a fuel cell system including an outer hot box housing surrounding one or more stacks of fuel cells, a resilient insulating material inside the outer housing surround the one or more stacks of solid oxide fuel cells and a compliant insulating layer located between the housing and the resilient insulating material.

Another embodiment relates to a method of sealing plumbing penetrations of a fuel cell system including providing a silicon coated fiberglass gasket around the plumbing penetrations through a hot box housing of the system and covering the gasket with a gasket frame.

Another embodiment relates to a solid oxide fuel cell system including one or more stacks of solid oxide fuel cells enclosed in a hot box housing, a fuel input conduit, an oxidant input conduit, at least one exhaust output conduit, at least one cavity in the housing comprising an insulation material that can be poured and at least one gasket around one or more of the fuel input, oxidant input and at least one exhaust output conduits. The gasket is configured to prevent loss of the insulation material that can be poured from the cavity.

### BRIEF DESCRIPTION OF THE DRAWINGS

FIG. 1A is a three dimensional cut-away view illustrating the base portion of a SOFC system according to a comparative example.

FIG. 1B is a schematic illustration of a cross section of a SOFC system according to an embodiment.

FIG. 2 is a three dimensional cut-away view illustrating the base portion of a SOFC system according to another embodiment.

FIG. 3 is a three dimensional cut-away view illustrating the base portion of a SOFC system according to another embodiment.

FIG. 4 is a three dimensional cut-away view illustrating the base portion of a SOFC system according to another embodiment.

FIG. 5 is an exploded view of gasket and frame for illustrating a SOFC system according to another embodiment.

### DETAILED DESCRIPTION

Embodiments of the present invention are drawn to solid oxide fuel cell (SOFC) systems and methods of insulating SOFC systems. Maintaining stable temperatures during operation of high temperature SOFC systems may improve both the thermal efficiency and the electrical efficiency of these systems. Embodiments include the use of an insulation material that can be poured (i.e., a pourable insulation material). One type of an insulation material that can be poured may be a “free flow” insulation which is a fluid that can be poured into an opening in the SOFC housing but which solidifies into a high temperature resistant material when cured. In an alternative embodiment, the insulation that can be poured is a flowable insulation material that does not need to be cured. In this embodiment, the material that can be poured is made of dry solid granular particles having the consistency of sand or pellets. Other embodiments include the combination of an insulation material that can be poured and a microporous insulating board. Still other embodiments are drawn to providing a compliant insulating layer between the sidewall of the SOFC housing and a resilient insulating layer inside the SOFC housing.

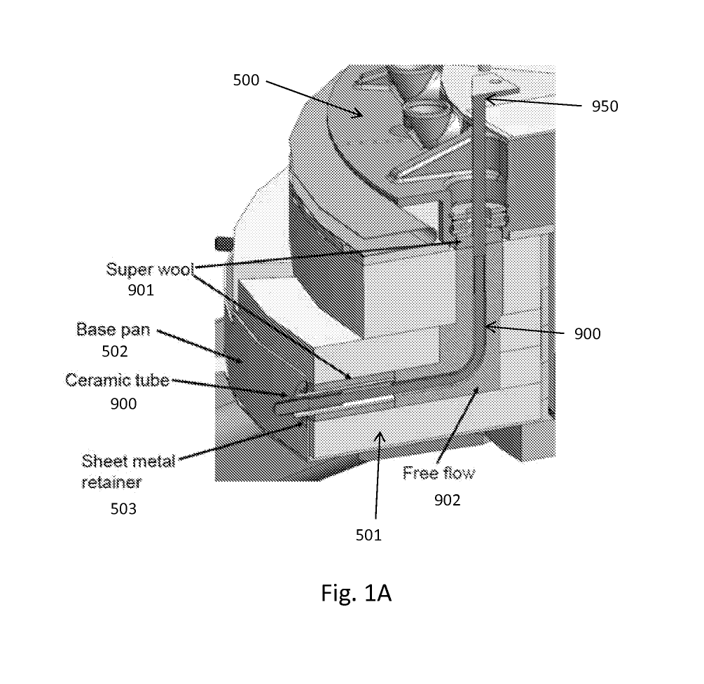

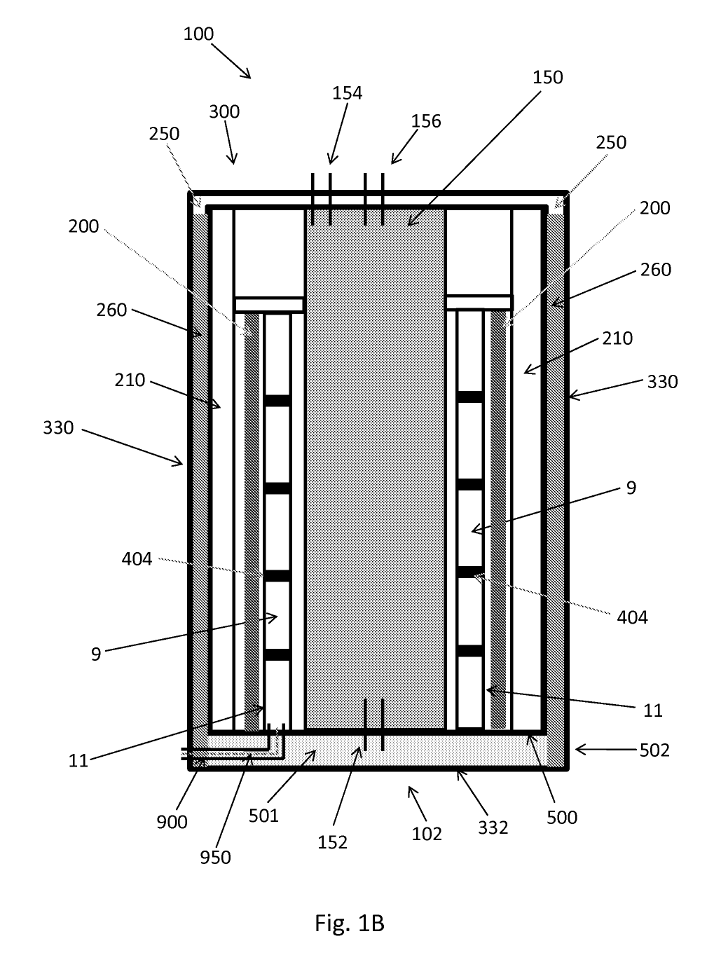

One method of insulating the base portion of a high temperature fuel cell system is disclosed in U.S. patent application Ser. No. 13/344,304, filed Jan. 5, 2012 and hereby incorporated by reference in its entirety. This method is illustrated in FIG. 1A. The fuel cell stacks (not shown) are positioned on a stack support base 500 which is located over a base pan 502 filled with insulation 501. In this method, the stack support base 500 contains a bridging tube 900 which eliminates the need for one of the seal elements. The bridging tube 900 may be made of an electrically insulating material, such as a ceramic, or it may be made of a conductive material which is joined to a ceramic tube outside the base pan 502. The use of a bridging tube 900 eliminates an air in to air out leak path. The current collector/electrical terminal 950 from the stacks is routed in the bridging tube 900 from top of the stack support base 500 through a base insulation 501 made of a microporous board and out of the base pan 502. A sheet metal retainer 503 may be used to fix the tube 900 to the base pan 502.

The tube 900 may be insulated in the base with super wool 901 and/or a pourable insulation material 902. The pourable insulation material may be the “free flow” insulation 902 which is a fluid that can be poured into an opening in the base 500 around the tube 900 and then solidifies into a high temperature resistant material when cured. Free flow 902 fills less than 10 volume % of the base cavity around the tube 900. In an alternative embodiment, the insulation material that can be poured 902 is made of dry solid granular particles.

FIG. 1B is a cross section illustrating a first embodiment of a SOFC system 100. The SOFC system 100 includes one or more columns 11 of fuel cell stacks 9 located on the stack support base 500. Each fuel cell stack includes one or more fuel cells as described in the U.S. patent application Ser. No. 13/344,304 hereby incorporated by reference in its entirety. Fuel manifolds 404 may be located between the fuel cell stacks 9 in the columns 11. The columns 11 of fuel cell stacks 9 may be located on a base plate 500 and arrayed about a central plenum 150. The central plenum 150 may include various balance of plant components, such as a reformer and/or heat exchanger, such as an anode cooler heat exchanger and/or an anode exhaust gas recuperator (not shown). The central plenum 150 of the SOFC system 100 also includes a fuel input conduit 152, an oxidant input conduit 154, a fuel/oxidant exhaust output conduit 156 (e.g., anode tail gas oxidizer output comprising fuel exhaust oxidized by the oxidant exhaust).

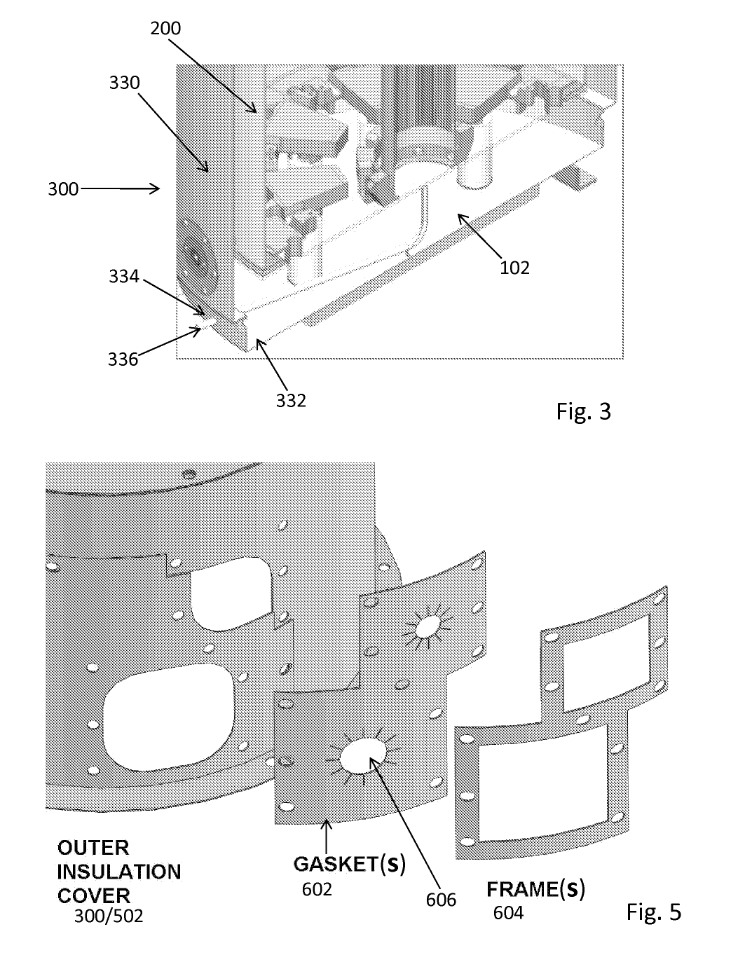

The SOFC system 100 also includes cathode recuperator 200 located about an outer periphery of the columns 11 of fuel cell stacks 9. To insulate the SOFC system 100 from heat loss, a resilient insulating layer 210 may be provided in the gap between the cathode recuperator 200 and the sidewall 330 of the outer housing 300 (e.g. hot box) of the SOFC system 100. To further insulate the SOFC system 100, a compliant insulating layer 260 may be provided in gap 250 between the resilient insulating layer 210 and the sidewall 330 of the outer housing 300 of the SOFC system 100. The resilient insulation layer 210 may be made of any suitable thermally insulating resilient material, such as a pourable material, e.g., a free flow material or a solid granular material. The compliant layer 260 may be made of any suitable material, such as thermally resistant felt, paper or wool. As used herein, a “compliant” material is a material that compresses and expands by at least 10 volume percent without damage. The base cavity 102 (also illustrated in FIG. 3) defined by stack support base 500, the bottom wall 332 of the base pan 502 of the housing 300 and the sidewall 330 of the outer housing 300 may be filled with a base insulation 901 such as a microporous board 501, a pourable insulation 902 or a combination thereof as discussed in more detail below. In an embodiment, the microporous board 501 fills less than or equal to one quarter of a volume of the base portion cavity 102 of the housing 300.

Transient heat fluctuations during operation of the SOFC, may cause the thin outer housing 330 (e.g. a metal housing) to expand and contract more rapidly than the more massive internal components of the SOFC system (e.g. stacks, etc.). This, in turn, may result in fatigue and damage to the insulation shell/containment and/or to the outer housing 300 and/or to the cathode recuperator. Further, absent a compliant insulating layer 260 in the gap 250 between the resilient insulating layer 210 and the sidewall of the outer housing 330, a gap may be generated sufficiently large to allow the compression resistant (i.e. resilient) pourable insulation 210 to escape the SOFC if the sidewall 330 of the outer housing 300 expands faster than the internal components of the SOFC system. However, the addition of a compliant insulating layer 260 in the gap 250 between the resilient insulating layer 210 and the sidewall of the outer housing 330 absorbs the stresses caused by expansion of the internal components of the SOFC, thereby protecting the outer housing 300, the cathode recuperator 200, the resilient layer 210 and/or the compliant insulating layer 260 and expands to fill any gaps formed if the outer housing 300 expands faster than the internal components of the SOFC. In other embodiments, at least 30 vol. %, such as at least 50%, e.g., 30-100 vol. %, e.g. 50-75 vol.% of the base cavity is filled with pourable insulation.

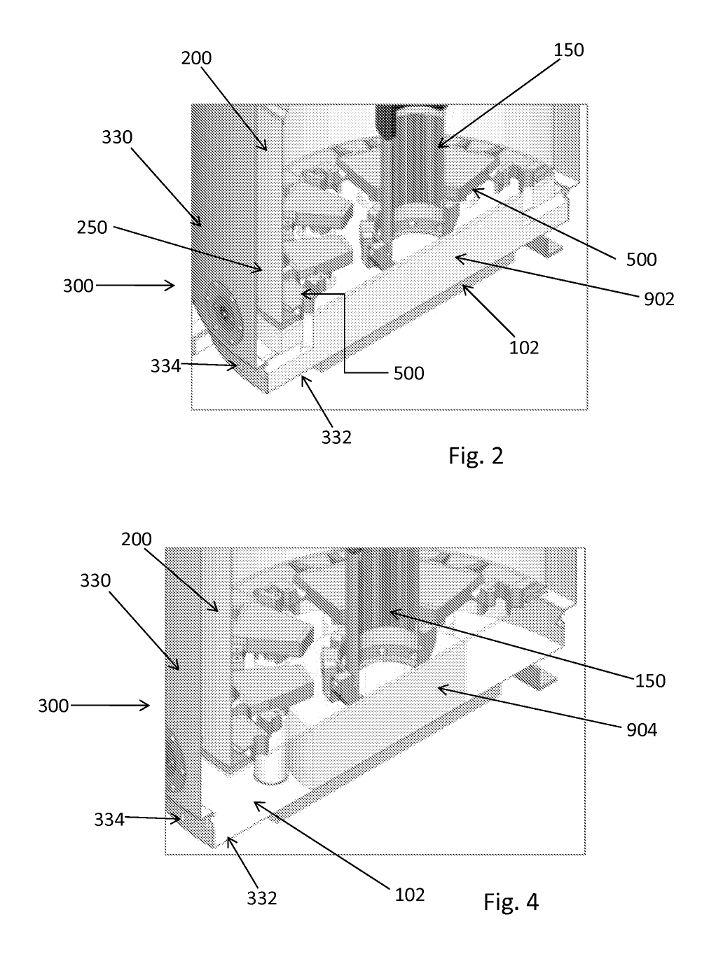

FIG. 2 illustrates another embodiment of a system. In this embodiment, the entire base cavity 102 in the base pan 502 below the stack support base 500 is completely filled with an insulation material that can be poured 902. The insulation that can be poured 902 is “self healing” in that it flows around tubing (e.g. tube 900) or instrumentation that is inserted into the base of the SOFC hot box. In this manner, the insulation material that can be poured 902 insulates against leaks due to feed-through holes made to introduce tubing or instrumentation into the SOFC. In an embodiment, a cavity between the side insulation (e.g. layers 210 and/or 260) and the base is opened to fill the base cavity 102 with pourable insulation 902 in a single step. In an embodiment, the resilient insulating layer 201 is made of the same material as the insulation that can be poured 902 and formed in one filling step after forming the compliant insulting layer 260. The insulation material that can be poured 902 may be supplied to the cavity 102 via an opening 334 in the sidewall 330 of the outer housing 300 of the system (e.g. opening 334 in the base pan 502).

FIG. 3 illustrates another embodiment of a method to fill the base cavity with insulation that can be poured. One end of a fill tube 336 extends out of the housing 300 through the opening 334 in the sidewall 330 of the housing 300. The other end is located in the base cavity 102 near a top portion of the base cavity 102, preferably near a central portion of the base cavity 102 (i.e. under the central plenum 150). In this embodiment, a vacuum may be applied to the fill tube 336 to aid with filling the base cavity 102 with material that can be poured 902 supplied, for example, through the gap between the cathode recuperator 200 and the housing 300.

Another embodiment is illustrated in FIG. 4. In this embodiment, a central portion of the base cavity 102 is filled with solid insulation, such as a microporous board 904. The remainder of the base cavity 102 is filled with insulation that can be poured 902.

FIG. 5 illustrates another embodiment. In this embodiment, a gasket 602 and a frame 604 are provided to assist in sealing of plumbing, such as a fuel input or oxidant input pipes or conduits, tube 900, and/or instrumentation penetrations through the outer housing 300. The gasket 602 made be made of any suitable material, such as silicon-coated fiberglass. The fiberglass provides high temperature resistance while the silicon coating restrains the fine particles of cavity-fill/material that can be poured 902 from flowing out of the base cavity 102. Preferably, the gasket 602 is made of a flexible material and can stretch slightly to accommodate expansion and contraction of the sidewall 330 of the outer housing 300 during operation of the SOFC.

A frame 604 may be provided to secure the gasket 602 to the sidewall 330 of the outer housing 300 (e.g. to the sidewall of the base pan 502 portion of he outer housing 300. For example, the gasket 602 may be secured by placing the gasket between the frame 604 and the sidewall 330 of the outer housing 300 and bolting the frame 604 to the sidewall 330 of the outer housing 300. The instrumentation, (thermocouples, etc.), pipes, tubes, etc. pass through openings 606 in the gasket(s) 602.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

1. A method of insulating a base portion of a fuel cell system, comprising:
pouring an insulation that can be poured to fill at least 30 volume % of a base portion cavity of the fuel cell system housing through an opening in a sidewall of the housing, wherein the base portion cavity of the housing is located between a bottom wall of the housing and a Stack support base plate located in the housing, wherein the stack support base plate supports one or more columns of fuel cell stacks.

2. The method of claim 1, further comprising supplying a fill tube through a wall of the housing and drawing a vacuum through the fill tube.

3. The method of claim 1, further comprising providing a thermally insulating porous board in a central portion of the base portion cavity of the housing, wherein the board fills less than or equal to one quarter of a volume of the base portion cavity of the housing.

4. The method of claim 1, wherein the entire base portion cavity is filled with insulation that can be poured and further comprising filling a side cavity and the base portion cavity in the same step.

5. The method of claim 1, wherein the insulation material comprises dry solid granular particles.

6. A fuel cell system, comprising:
a housing having a base portion cavity, wherein the base portion cavity of the housing is located between a bottom wall of the housing and a stack support base plate located in the housing, wherein the stack support base plate supports one or more columns of fuel cell stacks; and
insulation that can be poured in the base portion cavity.

7. The system of claim 6, further comprising a fill tube extending through a wall of the housing into the base portion cavity.

8. The system of claim 6, further comprising a thermally insulating porous board in a central portion of the base portion cavity of the housing, wherein the board fills less than or equal to one quarter of a volume of the base portion cavity of the housing; and a gasket around a conduit extending through a sidewall of the housing.

9. A method of insulating a sidewall of a fuel cell system housing comprising:
providing a compliant insulating layer between the sidewall and a resilient insulating material.

10. The method of 9, wherein the resilient insulating layer comprises a felt, paper, wool or material that can be poured.

11. The method of 9, wherein the compliant insulating layer compresses during operation of the system more than the resilient insulating material.

12. A fuel cell system, comprising:
an outer hot box housing surrounding one or more stacks of fuel cells;
a resilient insulating material inside the outer housing surround the one or more stacks of solid oxide fuel cells; and
a compliant insulating layer located between the housing and the resilient insulating material.

13. The system of claim 12, wherein the compliant insulating layer comprises a felt, paper or wool.

14. A method of sealing plumbing penetrations of a fuel cell system, comprising:
providing a silicon coated fiberglass gasket around the plumbing penetrations through a hot box housing of the system; and
covering the gasket with a gasket frame.

15. The method of claim 14, further comprising bolting the gasket is frame to the hot box housing.

16. The method of claim 15, wherein the gasket prevents loss of an insulation material that can be poured from a cavity inside the hot box housing.

17. The method of claim 14, wherein the gasket comprises a flexible material.

18. The method of claim 17, wherein the penetration comprises a conduit extending through a wall of a base pan portion of the hot box housing.

19. A solid oxide fuel cell system comprising:
one or more stacks of solid oxide fuel cells enclosed in a hot box housing;
a fuel input conduit;
an oxidant input conduit;
at least one exhaust output conduit;
at least one cavity in the housing comprising an insulation material that can be poured; and
at least one gasket around one or more of the fuel input, oxidant input and at least one exhaust output conduits, wherein the gasket is configured to prevent loss of the insulation material that can be poured from the cavity.

20. The system of claim 19, wherein the gasket comprises a flexible material.

21. The system of claim 20, wherein the gasket comprises silicon-coated fiberglass.

22. The system of claim 19, further comprising a gasket frame covering the gasket, wherein the gasket frame is affixed to the hot box housing.

23. The system of claim 22, wherein the gasket frame is affixed to the outside of a base pan portion of the hot box housing and the at least one of the fuel input, oxidant input or exhaust output conduits extend through an opening in the gasket.

24. The system of claim 19, wherein:
insulation material is located in a base cavity below the stacks; and
a resilient material, a compliant material and the insulation material are located around a side of the hot box housing.

25. The system of claim 19, wherein the insulation material comprises dry solid granular particles.
